(19) United States
(12) Patent Application Publication
(10) Pub. No.: US 2004/0196736 A1
(43) Pub. Date: Oct. 7, 2004

(54) Food stirring apparatus

(76) Inventor: Nancy C, Bordan, Fort Lauderdale, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/721,731

(22) Filed: Nov. 25, 2003

Related U.S. Application Data
(60) Provisional application No. 60/428,834, filed on Nov. 25, 2002.

(51) Int. Cl. B01F 7/00

(52) U.S. Cl. 366/286; 99/348

(57) ABSTRACT

A mixing apparatus having a casing adapted for being positioned adjacent to a cook top mixing area, a motor in the casing; a power supply in the casing and coupled to the motor for driving the motor; a mixing unit supported by and extending from the casing and coupled to and driven by the motor, wherein the mixing unit is detachably and selectively insertable in part into the casing for being driven by the motor; and a base provided with or without a securing member for releasably securing the casing to a substrate.

### CROSS-REFERENCES TO RELATED APPLICATION

This application claims the benefit of U.S. Provisional Application Serial No. 60/428,834, filed on Nov. 25, 2002, entitled MIXING APPARATUS and hereby references Disclosure Document No. 505,417, entitled STIR BUDDY, received by the United States Patent and Trademark Office on Feb. 12, 2002.

### TECHNICAL FIELD

This invention relates generally to mixer assemblies. More particularly, the present invention relates to electrically-driven motors and portable arrangements adapted for being selectively securable and conveniently accommodated with stove tops and ranges.

### BACKGROUND OF THE INVENTION

The prior art is replete with various constructions for kitchen appliances suitable for beating foods or the like, but not for use to stir foods during the cooking process. A representative sampling of such patents include U.S. Pat. Nos. 1,762,081; 2,185,155; 3,280,351; and 3,725,624.

U.S. Pat. No. 1,762,081, issued to Schleicher, shows a beater comprising an electric motor, a sleeve extending from the motor, a cup-shaped casing connected with this sleeve, a plate having an annular upstanding flange co-acting with the casing to produce an enclosure, and a shaft extending through the casing and the plate for coupling the shaft with the driving part of the motor. A gearwheel is rigidly secured to the shaft and a plurality of pinions continually meshing with the gear wheel is provided. A stub shaft is provided for each of the pinions and is rigidly connected with the casing. An arrangement is made whereby, when the motor is rotating, the shaft will rotate in one direction, while the plate will rotate in the opposite direction. This arrangement is for pre-cooking preparation, and requires connection with a fixed rotatable plate.

U.S. Pat. No. 2,185,155 discloses a food handling apparatus having a combination of a base, a pedestal at one end of the base, a power drive unit and an arrangement for pivotally mounting the power drive unit on the pedestal. The power drive unit includes a lower casing part and an upper casing part and these are detachably fastened together. The joint between the two parts is carefully concealed to provide an attractive appearance. This arrangement employs a gear arrangement, but the various mixing elements attached to shafts driven thereby are rotated concentrically about respectively fixed axes.

U.S. Pat. No. 3,280,351 discloses a mixer involving a gear arrangement for driving mixing elements coupled to respective shafts. These shafts are driven about axes concentric with the axes of rotation of the mixer elements.

In U.S. Pat. No. 3,725,624, a food mixer speed control rotary switch and beater ejector unit in which a multi-speed permutation rotor for switching multiple field coil windings is journalled on a plastic frame that supports axially spaced spring switch blades bearing radially on the rotor is disclosed. A beater ejection push rod is coaxially disposed therewith for the mutual support therewith in a readily assembled unit that includes a nested push button and dial assembly recessed protectively in the forward post of the food mixer handle. Mixer elements are supported on shafts that rotate coaxially therewith. These arrangements, as well as the arrangements discussed hereinabove, do not provide the type of flexibility or stirring called for in accordance with the present invention.

### SUMMARY OF INVENTION

The present invention provides for the stirring of food during the cooking process by a device which is mounted adjacent to the range or stovetop cooking area and has the flexibility of accommodating whatever pot or pan the cook is already using.

In accordance with the present invention, there is provided a mixing apparatus comprising a casing adapted for being positioned over a cook top mixing area, a motor in said casing, a power supply in said casing and coupled to said motor for driving said motor a mixing unit supported by and extending from said casing and coupled to and driven by said motor, wherein said mixing unit is comprised of a shaft and detachable paddles and is detachably and selectively insertable in part into said casing for being driven by said motor, a reduction gear member coupling said motor to said mixing unit, a lid adapted to accommodate said mixing unit and a base provided with or without a means of releasably securing said casing to a substrate.

The mixing apparatus of the present invention is used to facilitate the stirring of food items inside a pan or a pot while on the stove. The device offers the cook the opportunity to have the food items stirring while he or she is preparing other items, and can be used with any of the pots or pans that the cook is using.

The device can include a heavy plastic base containing the motor inside. Furthermore a stem from the base can extend upward, with another portion (an arm) extending across at about a 90-degree angle. The underside of the extended arm of the 90-degree angle accepts the insertion of the top section of a mixing unit, such as stirring device with paddles. The device may be either releasably secured to the kitchen counter by mechanical means beside the stove or range, or have its base beside the stove, with the arm having the ability to access the food items desired to be mixed (such as a sauce) inside a pan or pot. Alternatively, the base can be constructed so that it is of a weight sufficient to provide stability.

The device may further include a mixing unit such as a stirring device with a shaft and detachable paddles made of metal or heat resistant material, such as plastic, which can be available in an array of different sizes. This will be accomplished by having multiple sets of mixing units, namely shafts each with different sized paddles or a single shaft with multiple paddles that may be detachable from the shaft.

The device may further include lids of various sizes adapted with a hole in the center of the lid to accommodate the shaft of the mixing unit, allowing the lid to rest fully on top of the pot or pan being used.

### BRIEF DESCRIPTION OF THE DRAWINGS

FIG. 1 is a side view of the preferred embodiment of the present invention.

FIG. 2 is a side view of the preferred embodiment of the present invention.

FIG. 3 is an isometric view of the preferred embodiment of the present invention attached to a substrate for use.

FIG. 4 is a side view of a variation of the preferred embodiment of the present invention illustrating extendable regions of the apparatus.

### DETAILED DESCRIPTION OF THE PREFERRED EMBODIMENT

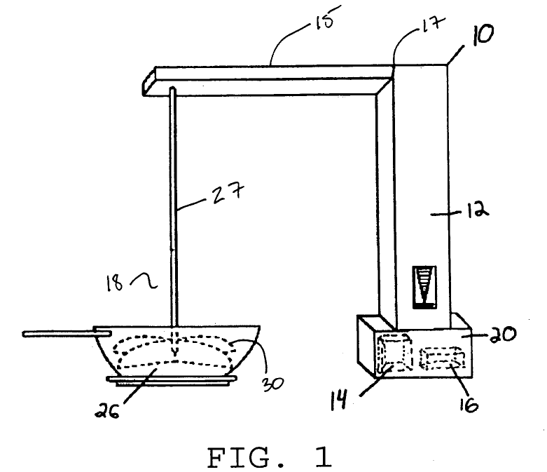

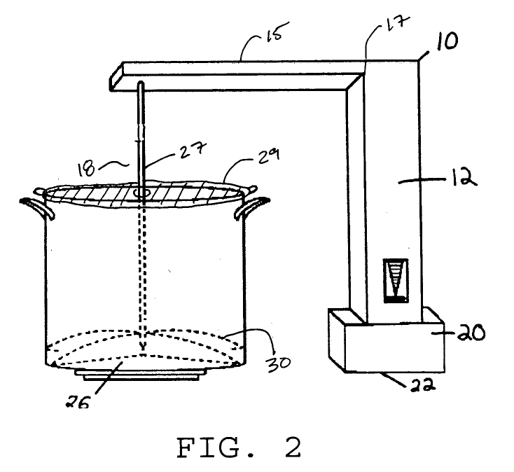

The preferred embodiment of the present invention provides for a stirring or mixing apparatus 10 used to facilitate the stirring of food items inside a pot or pan on a stove. Mixing apparatus 10 includes a motor 14 and a power supply 16 located in a base 20 of mixing apparatus 10 and enclosed by a casing 12, shown in FIGS. 1 and 2. Power supply 16 is coupled to motor 14 for the purpose of driving motor 14. Casing 12 can stem from base 20 upward, with an additional portion 15 extending across at about a ninety-degree angle. Portion 15 can be hinged with locking hinge 17 so that portion 15 can be folded against casing 12 for storage. Motor 14 is supported by and extends upward through casing 12 by means of a reduction gear member coupling or the like which attaches to a mixing unit 18, which is thereby driven by motor 14. Mixing unit 18 is detachably and selectively insertable into casing 12, preferably attaching on the underside of the ninety-degree extension of casing 12, where mixing unit 18 couples to motor 14 through the reduction gear member coupling. Mixing unit 18 extends downward from casing 12 into a mixing area 26, such as the area within a pot or pan containing food items to be stirred.

Mixing unit 18 may be comprised of a shaft 27 and detachable paddles 28.

Lid 29 is adapted with a hole in the center to accommodate the shaft of mixing unit 18 and rests fully on top of pot or pan being used.

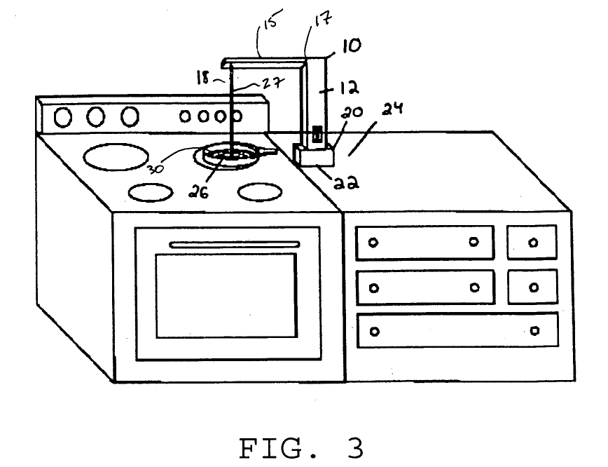

Base 20 of mixing apparatus 10 is releasably secured to a substrate 24, such as a kitchen counter, through the use of a securing member 22, as shown in FIG. 3. Alternatively, base 20 can be constructed without securing member 22, such that the weight of mixing apparatus 10 provides stability.

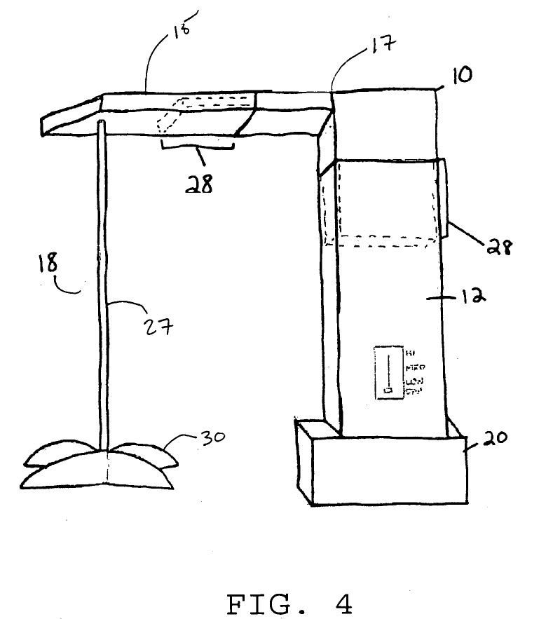

Mixing apparatus 10 may further include an extendable region 28, which would allow mixing apparatus to be adjusted into an appropriate position to ease the facilitation of mixing food items in mixing area 26, as shown in FIG. 4.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A mixing apparatus comprising:
a casing adapted for being positioned adjacent to a cook top mixing area;
a motor in said casing;
a power supply in said casing and coupled to said motor for driving said motor; and
a mixing unit supported by and extending from said casing and coupled to and driven by said motor, wherein said mixing unit extends into said mixing area and is detachably and selectively insertable in part into said casing for being driven by said motor.

2. The mixing apparatus of claim 1 further comprising a base provided with a securing member for releasably securing said casing to a substrate.

3. The mixing apparatus of claim 1 wherein said casing further comprises at least one extendable region.

4. The mixing apparatus of claim 2 wherein said mixing unit extends to a length beyond a length of said base.

5. The mixing apparatus of claim 1 further comprising a lid adapted to accept a shaft of said mixing unit.

6. The mixing apparatus of claim 1 wherein said mixing unit includes a shaft and paddles.

7. The mixing apparatus of claim 6 wherein said paddles are detachable from said shaft.
